(19) United States
(12) Patent Application Publication
(10) Pub. No.: US 2019/0385110 A1
(43) Pub. Date: Dec. 19, 2019

(54) Systems and methods for real-time delivery of training and testing and measurement of effectiveness Related to same

(71) Applicant: Broadcat LLC, Dallas, TX (US)

(72) Inventor: Ricardo Pellafone, Dallas, TX (US)

(21) Appl. No.: 16/442,105

(22) Filed: Jun. 14, 2019

Related U.S. Application Data
(60) Provisional application No. 62/685,079, filed on Jun. 14, 2018.

(51) Int. Cl. G06Q 10/06; G06Q 10/10

(52) U.S. Cl. CPC G06Q 10/06395; G06Q 10/105; G06Q 10/06398

(57) ABSTRACT

Systems and methods are provided for real-time delivery of online ethics and compliance training and testing and measurement of subsequent behavioral changes related to same. Ethics and compliance professionals may perform a series of actions including (1) log into an administrative platform that connects to the enterprise software their company uses for business operations, (2) select specific events that happen in that software via an event listener, and (3) create and customize ethics and compliance training messaging to be delivered when a selected event occurs. A reporting mode can be entered in which delivery of a training message may be tracked against a later, downstream event, whether that event occurred in the same piece of enterprise software or not. This may allow determination if the specific content delivered in an operational workflow was effective in influencing the behavior of employees, as shown by downstream data in a separate operational workflow.

### CROSS-REFERENCE TO RELATED APPLICATION

The present Applications claims the benefit of U.S. Provisional Application No. 62/685,079, filed Jun. 14, 2018, which is incorporated herein by reference in its entirety.

### FIELD OF THE DISCLOSURE

The present disclosure generally relates to training and measurement, and more particularly to real-time delivery of training and testing and measurement of effectiveness related to same.

### BACKGROUND

Traditionally, corporate ethics and compliance training has been delivered to employees outside of the context of their job duties using a centralized content management platform. Employees are assigned training related to abstract legal and risk concepts, including anti-corruption, antitrust, and fraud, on a scheduled basis. Employees log into a platform and take the training, which often includes a quiz to measure their comprehension, and then the employees are expected to apply the training to their specific job duties in the proper context and timing. This traditional method depicted in FIG. 4 relies on employees' ability to remember, issue-spot, and apply the ethics and compliance training at a later point in time—essentially, requiring them to act as miniature ethics and compliance attorneys with exceptionally good memories. The indeterminate and potentially lengthy time gap between the training and a relevant event, as well as the failure to tie the training to relevant real-world behaviors, have caused the field to struggle with how to measure training efficacy. The traditional method simply measures activity in the training environment or knowledge retention—leaving a large gap between the artificial training environment (where ethics and compliance issues are clearly salient) and the real world (where ethics and compliance issues often go unrecognized).

### SUMMARY

Embodiments of the present disclosure may provide systems and methods for real-time delivery of online ethics and compliance training and testing and measurement of subsequent behavioral changes related to same. Systems and methods may permit ethics and compliance professionals to perform a series of actions including, but not limited to, (1) log into an administrative platform that connects to the enterprise software that their company uses for business operations, (2) select specific events that happen in that software via an event listener, and (3) create and customize ethics and compliance training messaging to be delivered when a selected event occurs.

Embodiments of the present disclosure also may allow ethics and compliance professionals to enter a reporting mode, in which they may, among other things, track the delivery of a training message against a later, downstream event, whether that later event occurred in the same piece of enterprise software or not. For example, ethics and compliance professionals may compare records of compliance training about business gifts, delivered in the company's sales software, against a specific type of gift expense submitted by salespeople in the company's expense management software. This may allow ethics and compliance professionals to determine if the specific content delivered in the sales training workflow was effective in influencing the behavior of the sales team. Ethics and compliance professionals may test the efficacy of a compliance training message as against other training messages (AB testing) and/or over time (longitudinal testing).

Further embodiments of the present disclosure may provide a method for trigger-based compliance training, the method comprising: using an admin training configuration module within an interface of a configuration and reporting software, selecting a target software from a list of connected applications; selecting a trigger event from a list associated with the selected target software, wherein the trigger event is triggered via an event listener within an admin reporting module of the configuration and reporting software; selecting a compliance training message via a graphical user interface (GUI), wherein the compliance training message is displayed to an employee within the selected target software when the selected trigger event occurs; identifying one or more required/optional employee actions to be taken in response to display of the compliance training message; and activating trigger-based compliance training. When an optional AB test or a rotation workflow is utilized, the selecting the compliance training message step may further comprise creating alternative messaging or layouts; and setting frequency of rotation of the alternative messaging or layouts. The compliance training message may be selected from a library of pre-populated content. The one or more required/optional employee actions may be selected from the group comprising: checking a box, selecting a radio button, clicking a button, and combinations of the same. The compliance training message may be coded based on one or more substantive risk areas selected from the group comprising: anti-corruption, fraud, gifts and entertainment, and waste. The target software may be selected from the group comprising: design suite, marketing, sales customer relationship management (CRM), contract database, enterprise resource planning (ERP), expenses, payroll, employee hotline, and human resource information system (HRIS). More than one target software may be selected. The method also may include performing one or more reporting functions selected from the group comprising: examining all training given to the employee, examining all training records coded to be responsive to a specific risk or legal area, examining all training given in the target software, examining all training records given in response to the selected trigger event, examining the occurrence of the selected trigger event in more than one target software, and comparing and combining one or more of the reporting functions as secondary variables to determine correlation.

Other embodiments of the present disclosure may provide a compliance training measurement method comprising: selecting a trigger event, the trigger event representing an opportunity for compliance training, and wherein the trigger event is triggered via an event listener; selecting one or more training messaging and/or employee actions that are displayed to an employee when the trigger event occurs; and tracking the delivery of the one or more training messaging and/or employee actions against a later downstream event associated with the employee. The later downstream event may occur in the same or different enterprise software where the trigger event occurs. The later downstream event may be a job duty performance evaluation of the employee. The tracking step may comprise testing efficacy of a compliance training message as against one or more other training messages delivered to the employee and/or testing efficacy of a compliance training message over time.

Additional embodiments of the present disclosure may provide a trigger-based compliance training system comprising: a configuration and reporting software comprising: an admin training configuration module having a graphical user interface (GUI) that prompts selection of a target software from a list of connected applications, a trigger event from a list associated with the selected target software, a compliance training message to be displayed to an employee within the selected target software when the selected trigger event occurs, and one or more required/optional employee actions to be taken in response to display of the compliance training message; and an admin reporting module including an event listener that listens for the selected trigger event within the selected target software, receives notification of the one or more required/optional employee actions taken in response to display of the compliance training message, and reports whether and how the compliance training message affected actions of the employee within the selected target software. The one or more required/optional employee actions may be selected from the group comprising: checking a box, selecting a radio button, clicking a button, and combinations of the same. The compliance training message may be coded based on one or more substantive risk areas selected from the group comprising: anti-corruption, fraud, gifts and entertainment, and waste. The target software may be selected from the group comprising: design suite, marketing, sales customer relationship management (CRM), contract database, enterprise resource planning (ERP), expenses, payroll, employee hotline, and human resource information system (HRIS). When an optional AB test or a rotation workflow is utilized, the selecting the compliance training message step may further comprise creating alternative messaging or layouts; and setting frequency of rotation of the alternative messaging or layouts. The reporting within the admin reporting module may comprise an evaluation of efficacy of the compliance training message as against one or more other training messages delivered to the employee and/or an evaluation of efficacy of the compliance training message over time.

### BRIEF DESCRIPTION OF THE DRAWINGS

For a more complete understanding of this disclosure, reference is now made to the following description, taken in conjunction with the accompanying drawings, in which:

FIG. 1 depicts an administrator interface workflow for creating a trigger-based training according to an embodiment of the present disclosure;

FIG. 2 depicts a use case according to an embodiment of the present disclosure;

FIG. 3 depicts an implementation structure according to an embodiment of the present disclosure;

FIG. 4 depicts a training model according to the prior art; and

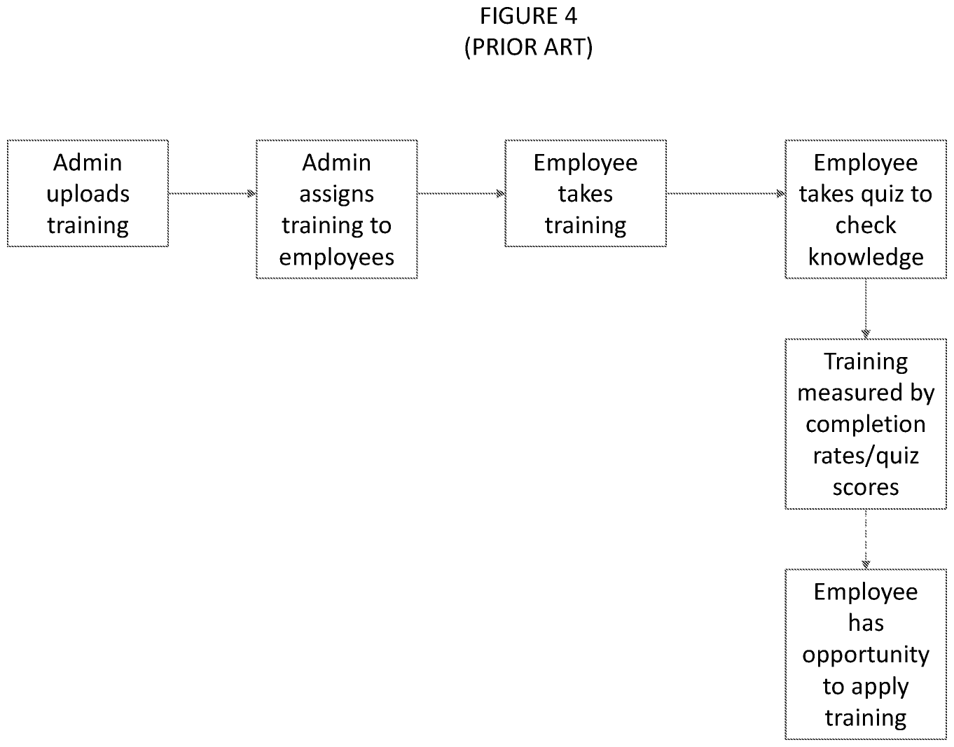

FIG. 5 depicts a training measurement method according to an embodiment of the present disclosure.

### DETAILED DESCRIPTION

Embodiments of the present disclosure tie the delivery of ethics and compliance training to the execution of known process steps or events in other business processes, as memorialized in other enterprise software. Accordingly, employees may receive relevant, timely messaging that gives them clear direction on the processes that they are executing. Employees are not required to memorize, issue-spot, or determine how to apply the compliance training, because systems and methods according to embodiments of the present disclosure does this for them. Employees may be presented with relevant factors to consider and apply in a situation where human judgment is required on a potential ethical or compliance issue.

Moreover, by framing corporate ethics and compliance in the context of specific business tasks that serve as leading or lagging indicators of potential misconduct, testing and measurement of training efficacy becomes possible. Ethics and compliance administrators can use the system's event listener to not only capture events that require the delivery of ethics and compliance messaging, but compare the incidence of those events to downstream process outcomes—whether they occur in the same business process and are captured by the same operational software or not.

Embodiments of the present disclosure recognize that wide swaths of corporate misconduct occur in, or are reducible to, electronic records, and effective compliance training should be strongly correlated to a difference in those records. For example, an ethics and compliance administrator could elect to use the system to target enterprise sales software, choosing to trigger ethics and compliance messaging on gifts and entertainment rules when a salesperson updates a potential customer's record to indicate that the salesperson will be visiting the prospect for a presentation. The ethics and compliance administrator could then choose to use systems and methods according to embodiments of the present disclosure to compare the salesperson's viewing of the training with the expense report data submitted in the company's enterprise expense management software. This may allow an ethics and compliance administrator to see how presenting the gifts and entertainment training influenced the salesperson's behavior, comparing the guidance the salesperson received (and the salesperson's response, if any) to any expense reports containing gifts and entertainment line items. Traditionally, these elements would be siloed off—the training would not be tied to the later outcome due to the training being “owned” by the compliance team and the expense management software being “owned” by the finance team. Systems and methods according to embodiments of the present disclosure tie these elements together.

Embodiments of the present disclosure may allow ethics and compliance professionals to properly test training events, both initially and over time. Continuing with the above example, an ethics and compliance administrator could test multiple versions of the gifts and entertainment messaging, comparing each version against the later outcome to determine which performed the best, in the manner of a AB test. In addition, the ethics and compliance administrator could use the expense report data to track the performance of the training over time, updating the visual layout or required action if the training became too familiar and therefore, less effective as a behavioral intervention. Finally, the ethics and compliance administrator could use the system to create and test rotations of ethics and compliance messaging, increasing the impact of novelty on the training messaging and determining the optimal cycle of messaging to maintain the desired behavior as shown from the expense report data. Testing according to embodiments of the present disclosure may allow ethics and compliance professionals to test the effects of certification and/or whether the effectiveness of messaging begins to decay. Through this testing, ethics and compliance professionals may intervene by rotating or alternating the visual presentation and/or messaging.

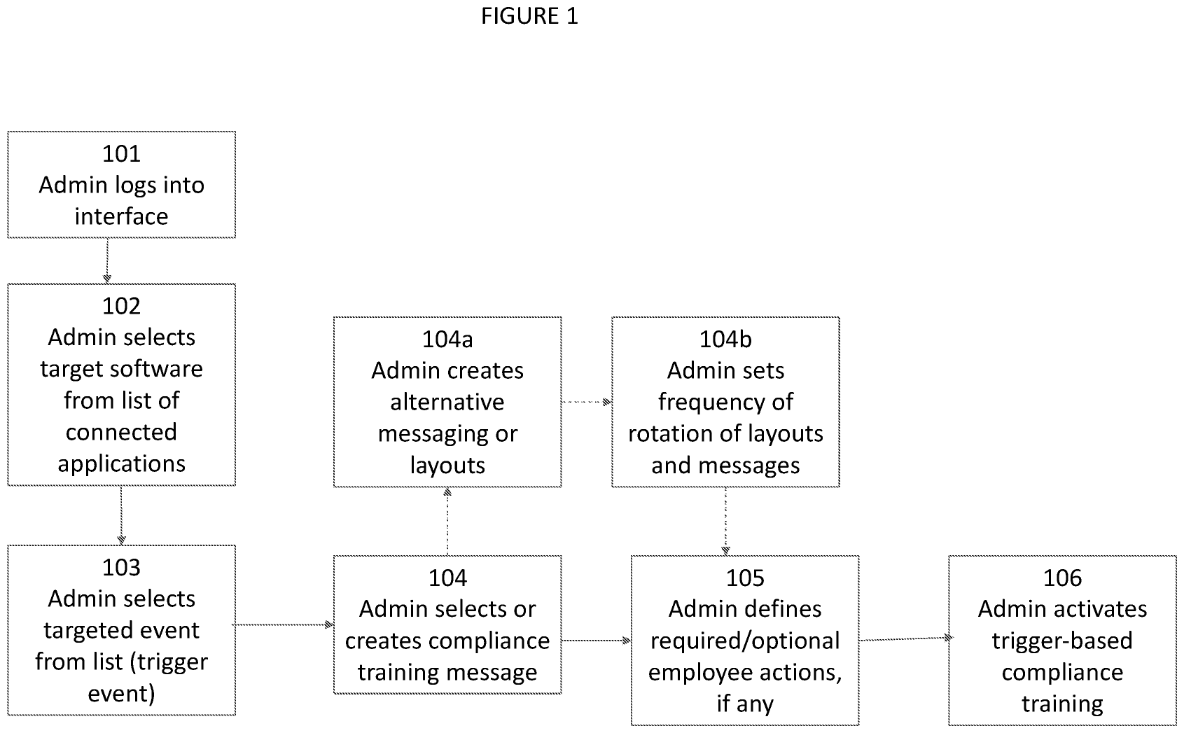

Embodiments of the present disclosure may allow ethics and compliance professionals to target specific software events for training delivery, and then compare them with later actions in other connected enterprise software to determine and measure the appropriate behavioral outcomes. FIG. 1 depicts an administrator interface workflow for creating a trigger-based training according to an embodiment of the present disclosure. An administrator may log into the interface (step 101). The administrator may select a target software from a list of connected applications (step 102). It should be appreciated that the list of connected applications may include one or more applications in embodiments of the present disclosure. The administrator may then select a targeted event from a list that may be associated with the selected target software (step 103). This may be referred to as a trigger event in embodiments of the present disclosure. This list of triggering events may represent events that may occur as part of normal business operations. For example, a triggering event related to expense software may be “expense report with exceptions is ready for approval.” Again, the list of triggering events may vary depending on the module or piece of software being targeted in embodiments of the present disclosure.

The administrator (i.e., an ethics and compliance professional) then may select from a library of pre-populated content or create a compliance training message via a GUI (step 104). This compliance training message may be shown to an employee when the selected trigger event occurs. If an optional AB test or rotation workflow is utilized, the administrator may then create alternative messaging and/or layouts (step 104a) and set frequency and/or rotation of messaging and/or layouts (step 104b). It should be appreciated that the administrator may optionally code the messaging based on one or more substantive risk areas. For example, if the administrator has selected the “expense report with exceptions” messaging, this messaging may be coded with one or more risk areas including, but not limited to, anti-corruption, fraud, gifts and entertainment, and waste. The ethics and compliance professionals can also optionally choose alternate layouts or actions for the messaging to be shown on a rotating basis, as well as set the frequency of the rotation. The administrator may define required and/or optional employee actions, if any, that an employee may be required to complete before advancing (step 105). Actions may include, but are not limited to, checking a box, selecting a radio button, clicking a button, and/or combinations of same. The administrator may then activate trigger-based compliance training (step 106).

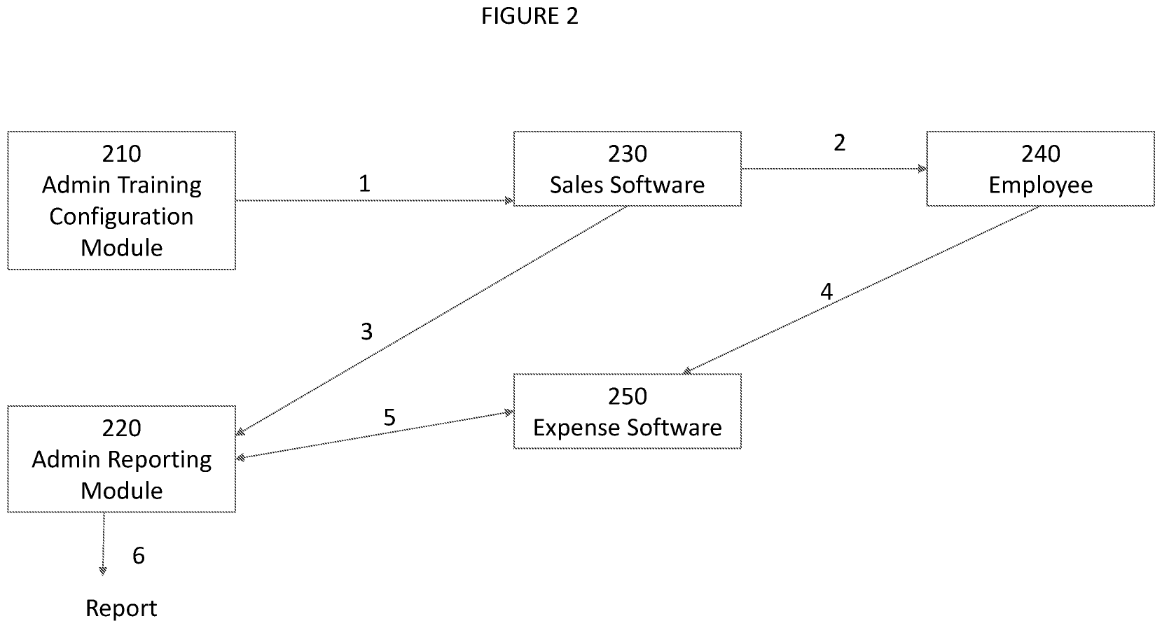

FIG. 2 depicts a use case according to an embodiment of the present disclosure. Using admin training configuration module (210), an administrator may configure gifts compliance training to be triggered when the sales person changes a deal property to “presentation scheduled” (step 1). Sales software (230) may deliver a training message to a sales person (employee 240) when he/she updates the deal property (step 2). Sales software (230) may then report a training event to admin reporting module (220) (step 3). A sales person (employee 240) may submit an expense report via expense software (250) after delivering a sales presentation (step 4). Admin reporting module (220) may listen for events that occur in expense software (250) (step 5). The administrator may then run a report that compares a training record (or group of training records) against the expense report (or a group of expense reports) that is/are submitted through expense software (250) to determine if and how the training impacted gift actions (step 6). While certain pieces of software are described in the use case of FIG. 2, it should be appreciated that admin training configuration module (210) and admin reporting module (220) may communicate with one or more pieces of different software without departing from the present disclosure. Similarly, employee (240) may interact with one or more pieces of software different from that described in FIG. 2 without departing from the present disclosure.

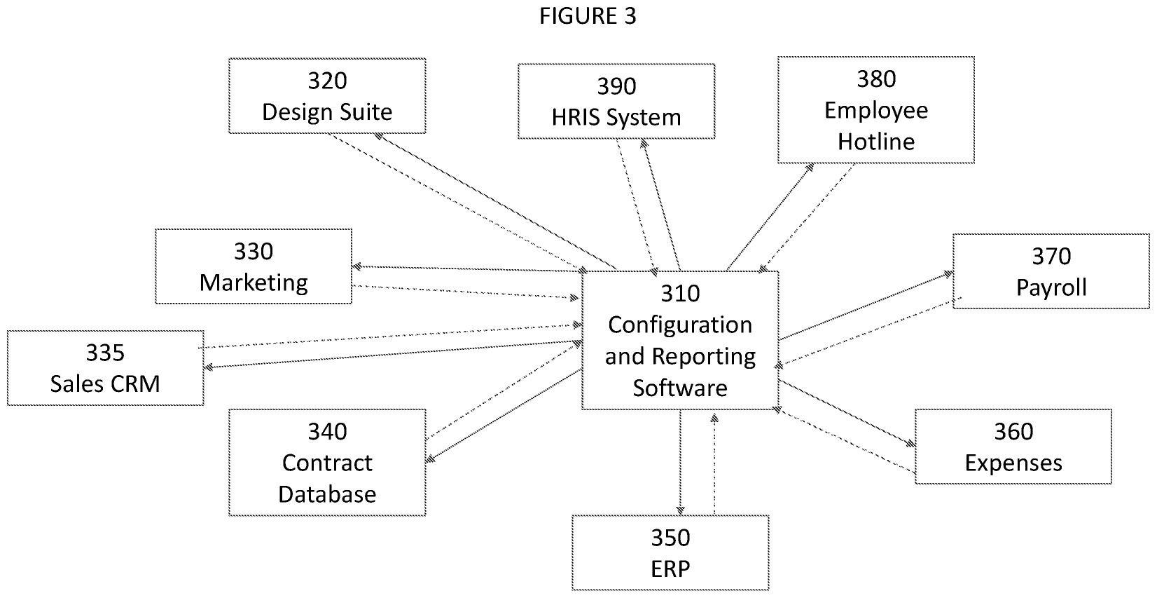

FIG. 3 depicts an implementation structure according to an embodiment of the present disclosure. As depicted herein, communication and reporting software 310 may serve as a hub to provide an interface to send instructions on executing compliance training within normal workflows. This is generally depicted through the solid arrows in FIG. 3. Operational software can be polled by the interface according to embodiments of the present disclosure to listen for triggering events and capture other events for purposes of determining correlation between training events and upstream or downstream behavior. These operations are depicted by the broken lines in FIG. 3. These triggering events and other events may originate with one or more modules including, but not limited to, design suite (320), marketing (330), sales customer relationship management (CRM) (335), contract database (340), enterprise resource planning (ERP) (350), expenses (360), payroll (370), employee hotline (380), and/or human resource information system (HRIS) (390). Again, while several modules are shown and described in FIG. 3, it should be appreciated that more or fewer modules may communicate with configuration and reporting software (310) without departing from the present disclosure. For example, other modules may include, but are not limited to, document execution software and procurement platforms.

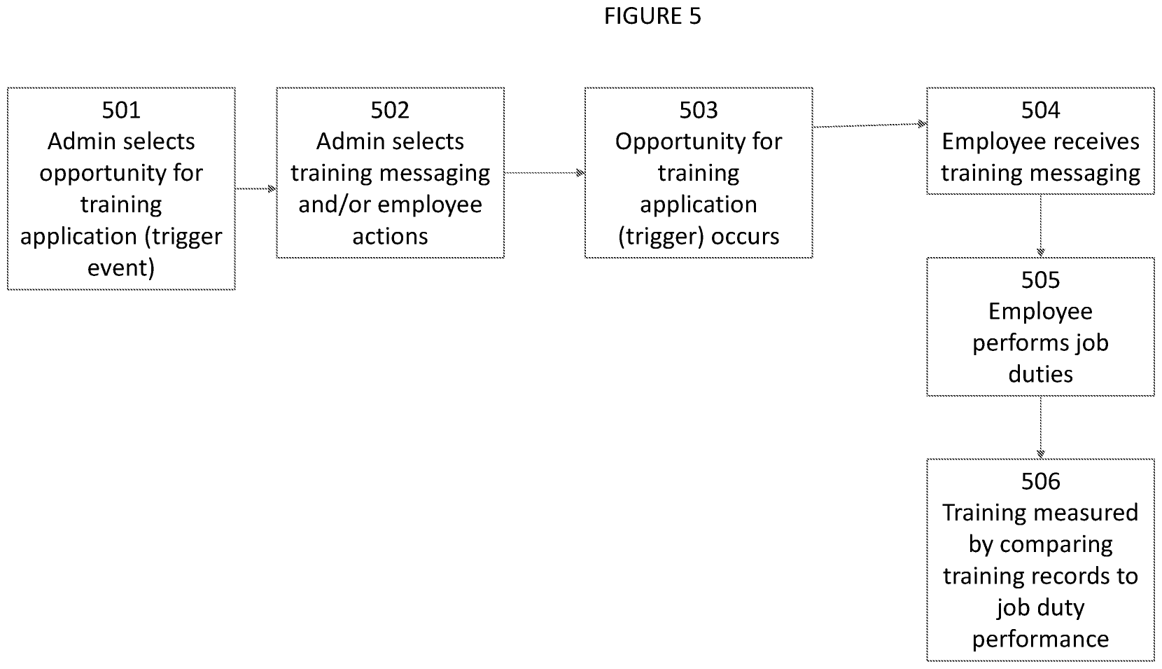

FIG. 5 depicts a training measurement method according to an embodiment of the present disclosure. In this method, an administrator may select an opportunity for training application, which may be referred to as a trigger event (step 501). The administrator may select training messaging and/or any employee actions (step 502). When an opportunity for training application (i.e., a trigger event) occurs (step 503), an employee may receive training messaging (step 504). The employee may then perform his/her job duties (step 505), and the training that the employee received may be measured by comparing training records to the employee's performance of his/her job duties (step 506). Accordingly, the training activity may be tied to downstream behavior.

Accordingly, systems and methods according to embodiments of the present disclosure may provide for real-time, event-triggered delivery of content. When ethics and compliance professionals log into an administrative platform or interface (i.e., FIG. 1, step 1), this interface may be connected to enterprise software that may be used for business operations. This enterprise software may include, but is not limited to, one or modules as depicted in FIG. 3. Systems and methods according to embodiments of the present disclosure may allow ethics and compliance professionals to select one or more modules or pieces of software to be targeted. Once appropriate trigger events and messaging have been activated, an employee performing relevant job duties≠for example, an accounts payable clerk reviewing an expense report submitted for approval≠may be presented with the relevant ethics and compliance messaging natively in the application that he/she may be using (e.g., expense management software). The employee's receipt of the messaging, as well as the outcome of any required actions that the employee may be required to take (as optionally determined by the ethics and compliance administrator) may be transmitted back to the admin system and recorded in one or more databases for later use.

Systems and methods according to embodiments of the present disclosure also provide for outcome testing and measurement. Ethics and compliance professionals may be able to select one or more reporting functions including, but not limited to, examining all training given to a specified employee, examining all training records coded to be responsive to a specific risk or legal area, examining all training records given a specified piece of enterprise software, examining all training records given in response to a specified trigger event, examining the occurrence of any targetable event in any piece of connected software, whether or not that event has been actually targeted for training, and comparing and combining any of the above as secondary variables to another primary variable to determine correlation. Additional functions may include, but are not limited to, comparing a training record with a later event, for example, training on gifts compliance given in sales software against expense management reporting, to determine the efficacy of the training, comparing multiple training scenarios against later outcomes to determine the top-performing training messaging, with the ability to select the top-performing messaging to replace all other messaging (either manually or by automated process), comparing historical event performance for trends, determining longitudinal performance of training activity, running regression analyses to isolate variables and determine casual relationships between specific training activities and later target events, and building and exporting data tables and reports to programs including, but not limited to, Microsoft Excel, Microsoft PowerPoint, and Adobe PDF for purposes of reporting to stakeholders.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method for trigger-based compliance training, the method comprising:
using an admin training configuration module within an interface of a configuration and reporting software, selecting a target software from a list of connected applications;
selecting a trigger event from a list associated with the selected target software, wherein the trigger event is triggered via an event listener within an admin reporting module of the configuration and reporting software;
selecting a compliance training message via a graphical user interface (GUI), wherein the compliance training message is displayed to an employee within the selected target software when the selected trigger event occurs;
identifying one or more required/optional employee actions to be taken in response to display of the compliance training message; and
activating trigger-based compliance training.

2. The method of claim 1, wherein when an optional AB test or a rotation workflow is utilized, the selecting the compliance training message step further comprises:
creating alternative messaging or layouts; and
setting frequency of rotation of the alternative messaging or layouts.

3. The method of claim 1, wherein the compliance training message is selected from a library of pre-populated content.

4. The method of claim 1, wherein the one or more required/optional employee actions are selected from the group comprising:
checking a box, selecting a radio button, clicking a button, and combinations of the same.

5. The method of claim 1, wherein the compliance training message is coded based on one or more substantive risk areas selected from the group comprising:
anti-corruption, fraud, gifts and entertainment, and waste.

6. The method of claim 1, wherein the target software is selected from the group comprising:
design suite, marketing, sales customer relationship management (CRM), contract database, enterprise resource planning (ERP), expenses, payroll, employee hotline, and human resource information system (HRIS).

7. The method of claim 1, wherein more than one target software is selected.

8. The method of claim 1 further comprising:
performing one or more reporting functions selected from the group comprising: examining all training given to the employee, examining all training records coded to be responsive to a specific risk or legal area, examining all training given in the target software, examining all training records given in response to the selected trigger event, examining the occurrence of the selected trigger event in more than one target software, and comparing and combining one or more of the reporting functions as secondary variables to determine correlation.

9. A compliance training measurement method comprising:
selecting a trigger event, the trigger event representing an opportunity for compliance training, and wherein the trigger event is triggered via an event listener;
selecting one or more training messaging and/or employee actions that are displayed to an employee when the trigger event occurs; and
tracking the delivery of the one or more training messaging and/or employee actions against a later downstream event associated with the employee.

10. The compliance training measurement method of claim 9, wherein the later downstream event occurs in the same enterprise software where the trigger event occurs.

11. The compliance training measurement method of claim 9, wherein the later downstream event occurs in a different enterprise software than where the trigger event occurs.

12. The compliance training measurement method of claim 9, wherein the later downstream event is a job duty performance evaluation of the employee.

13. The compliance training measurement method of claim 9, wherein the tracking step comprises:
testing efficacy of a compliance training message as against one or more other training messages delivered to the employee.

14. The compliance training measurement method of claim 9, wherein the tracking step comprises:
testing efficacy of a compliance training message over time.

15. A trigger-based compliance training system comprising:
a configuration and reporting software comprising:
an admin training configuration module having a graphical user interface (GUI) that prompts selection of a target software from a list of connected applications, a trigger event from a list associated with the selected target software, a compliance training message to be displayed to an employee within the selected target software when the selected trigger event occurs, and one or more required/optional employee actions to be taken in response to display of the compliance training message; and
an admin reporting module including an event listener that listens for the selected trigger event within the selected target software, receives notification of the one or more required/optional employee actions taken in response to display of the compliance training message, and reports whether and how the compliance training message affected actions of the employee within the selected target software.

16. The system of claim 15, wherein the one or more required/optional employee actions are selected from the group comprising:
checking a box, selecting a radio button, clicking a button, and combinations of the same.

17. The system of claim 15, wherein the compliance training message is coded based on one or more substantive risk areas selected from the group comprising:
anti-corruption, fraud, gifts and entertainment, and waste.

18. The system of claim 15, wherein the target software is selected from the group comprising:
design suite, marketing, sales customer relationship management (CRM), contract database, enterprise resource planning (ERP), expenses, payroll, employee hotline, and human resource information system (HRIS).

19. The system of claim 15, wherein when an optional AB test or a rotation workflow is utilized, the selecting the compliance training message step further comprises:
creating alternative messaging or layouts; and
setting frequency of rotation of the alternative messaging or layouts.

20. The system of claim 15, wherein the reporting within the admin reporting module comprises:
an evaluation of efficacy of the compliance training message as against one or more other training messages delivered to the employee and/or an evaluation of efficacy of the compliance training message over time.
